(19) United States
(12) Patent Application Publication
(10) Pub. No.: US 2016/0016527 A1
(43) Pub. Date: Jan. 21, 2016

(54) INFLATABLE HEEL BLOCKER

(71) Applicant: FORD GLOBAL TECHNOLOGIES, LLC, Dearborn, MI (US)

(72) Inventors: Brandon Aselage, White Lake, MI (US); Sean Bayle West, Monroe, MI (US); Stacey H. Raines, Ypsilanti, MI (US); Kirk David Arthurs, Newport, MI (US)

(21) Appl. No.: 14/336,644

(22) Filed: Jul. 21, 2014

(51) Int. Cl. B60R 21/20; B60R 21/235; B60R 21/0132; B60R 21/215; B60R 21/268

(52) U.S. Cl. CPC B60R 21/20; B60R 21/215; B60R 21/268; B60R 21/0132; B60R 21/235; B60R 2021/23176

(57) ABSTRACT

An inflatable heel blocker is provided for protecting an operator of a motor vehicle in the event of an accident. The heel blocker includes an inflatable bladder having a first portion secured to the floor plan pan adjacent the toe pan and underneath the vehicle control pedals. Significantly, when deployed, the rearmost and lowermost portion of the bladder is secured to the floor pan thereby maximizing the effectiveness of the device.

### TECHNICAL FIELD

This document relates generally to vehicle safety devices and, more particularly, to an inflatable heel blocker that normally extends flat along the floor panel adjacent the toe pan and is deployed in the event of an accident to protect the feet, heels and lower legs of the vehicle operator.

### BACKGROUND

This document relates to an inflatable heel blocker which protects the feet, heels and lower legs of an operator of a motor vehicle in the event of an accident. Toward this end, the heel blocker has two major functions. First it facilitates better engagement between the knee and knee bolster thereby improving lower leg and femur loading as well as kinematics by limiting heel travel into the toe pan area. Second it provides an inflatable bladder for energy management and as an additional dampener of forces associated with an accident such as a head-on or off-set frontal collision.

### SUMMARY

In accordance with the purposes and benefits described herein an inflatable heel blocker is provided for protecting an operator of a motor vehicle during an accident wherein that motor vehicle includes a floor pan, a toe pan forward of the floor pan and vehicle control pedals. The heel blocker may be broadly described as comprising an inflatable bladder having a first portion secured to the floor pan adjacent the toe pan and underneath the vehicle control pedals. In one possible embodiment the inflatable bladder is exclusively mounted to the floor plan and inflates in a direction upwardly from the floor pan adjacent and along an interior face of the toe pan toward the vehicle control pedals. Further the rearmost and lowermost portion of the bladder is secured to the floor pan at all times so as to prevent any possibility of the heels of the operator undercutting or submarining the inflatable bladder as a result of the forces that are produced in a frontal collision.

The heel blocker has a home position extending flat along the floor pan adjacent the toe pan and a deployed position in an area bounded by a bottom of the vehicle control pedals, the toe pan and the floor pan. Further the deployed area is defined at a first end by a foot rest and a second end by a center console or tunnel of the motor vehicle. The heel blocker has an inflation direction that is substantially at a tangent to a control surface of the vehicle control pedals (brake pedal and accelerator pedal).

In one possible embodiment the first portion of the inflatable bladder is heat welded to the floor pan. In another possible embodiment the first portion of the inflatable bladder is heat staked to the floor pan. In one possible embodiment the inflatable bladder is secured to the floor pan underlying a carpet. In one possible embodiment the carpet overlying the inflatable bladder is scored to allow the inflatable bladder to deploy through the carpet along the scoring. In another possible embodiment the inflatable bladder is secured to the floor pan underlying a layer of noise insulation material and a layer of carpet. In one possible embodiment the layer of noise insulating material and the layer of carpet overlying the inflatable bladder are both scored to allow the inflatable bladder to deploy through the insulating material and carpet layers along the scoring.

In any of the embodiments the inflatable bladder includes an air inlet and a pressurized fluid source that is connected to the air inlet. Further the inflatable heel blocker may include a controller and a motion sensor for detecting sudden deceleration associated with a motor vehicle accident. The controller is responsive to the motion sensor to activate the pressurized fluid source and deploy the inflatable bladder when the motion sensor detects the sudden deceleration characteristic of or associated with an accident.

In accordance with an additional aspect, a method of protecting the feet, heels and lower legs of an operator of a motor vehicle is provided. The method comprises the steps of securing an inflatable bladder to the floor pan adjacent the toe pan, deploying the inflatable bladder into an area defined by the bottom of the vehicle control pedals, the toe pan and the floor pan in the event of an accident. Thus, the method includes inflating the bladder upwardly from the floor pan adjacent and along an interior face of the toe pan toward the vehicle control pedals rather than toward the operator of the vehicle. Thus, the method includes inflating the bladder in a direction substantially at a tangent to a control surface of the vehicle control pedals. Further, one embodiment of the method includes exclusively mounting the inflatable bladder to the floor pan.

In accordance with an additional aspect a motor vehicle is provided incorporating the inflatable heel blocker as described.

In the following description, there is shown and described several preferred embodiments of the heel blocker. As it should be realized, the heel blocker is capable of other, different embodiments and its several details are capable of modification in various, obvious aspects all without departing from the heel blocker as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the heel blocker and together with the description serve to explain certain principles thereof. In the drawings:

FIG. 1a and is a perspective view of the foot pedal operating area of a vehicle with the heel blocker in the home or undeployed position underlying the carpet.

FIG. 1b is a detailed end elevational and partially sectional view illustrating the heel blocker in the home or undeployed position.

FIG. 2a is a perspective view similar to FIG. 1a but is instead showing the heel blocker in the deployed position.

FIG. 2b is a detailed end elevational and partially sectional view showing the heel blocker in the deployed position.

FIG. 3 is a schematical block diagram of the heel blocker including the inflation and control circuit.

FIG. 4 is a view similar to FIG. 2b of an alternative embodiment of the invention.

Reference will now be made in detail of the present preferred embodiments of the heel blocker, examples of which are illustrated in the accompanying drawings.

### DETAILED DESCRIPTION

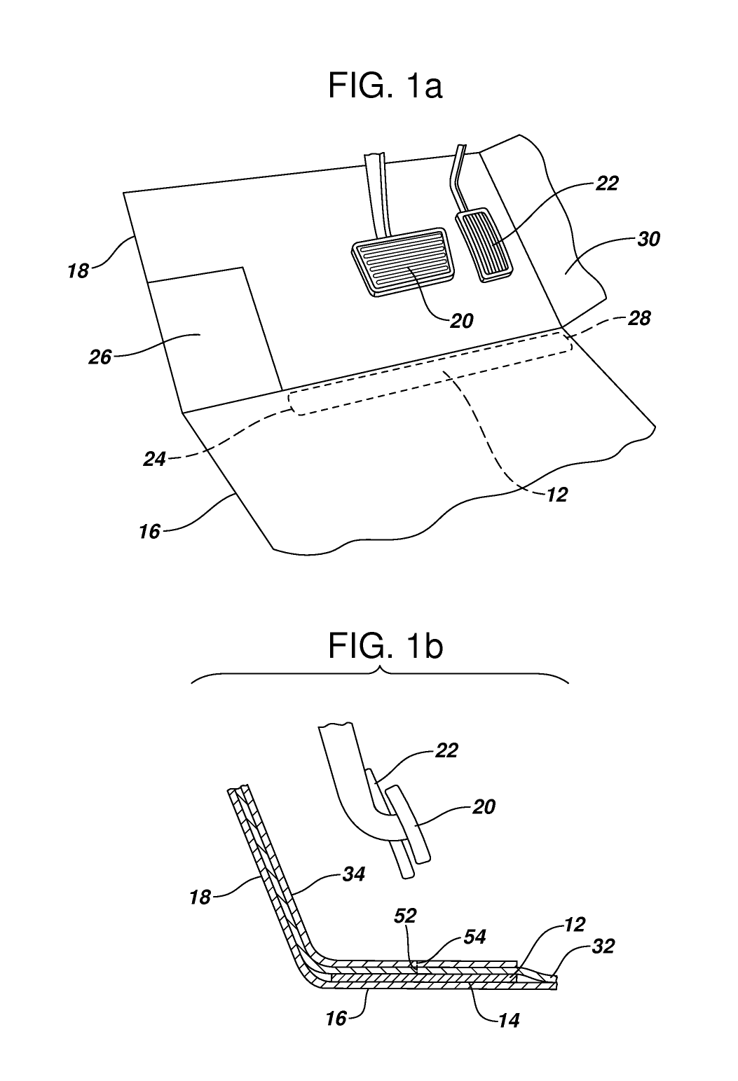

Reference is now made to FIGS. 1a and 1b illustrating the heel blocker 10 that is the subject of this document. More specifically, the heel blocker 10 comprises an inflatable bladder 12. Inflatable bladder 12 may be made from substantially any appropriate material including, for example, injection molded or blow molded plastic material such as polyethylene, polyolefin or PVC. A first or lowermost portion 14 of the bladder 12 is secured to the floor pan 16 of the motor vehicle adjacent the toe pan 18 and underneath the vehicle control pedals which comprise a brake pedal 20 and accelerator pedal 22 in the illustrated embodiment. As should be appreciated, in one possible embodiment the inflatable bladder 12 is exclusively mounted to the floor pan 16. By that, it is meant that no part of the bladder 12 is mounted or secured to the toe pan 18.

As further illustrated in FIGS. 1a and 1b, the bladder 12 extends from a first end 24 adjacent a footrest 26 to a second end 28 adjacent a console or center tunnel 30.

In the illustrated embodiment the bladder 12 is provided in a position underlying a layer 32 of noise insulation material and a layer 34 of carpet. In another possible embodiment, only an overlying carpet layer 34 is provided. There is no noise insulation layer 32. In still another possible embodiment neither of the layers 32, 34 is provided and the bladder 12 is simply provided in a cavity or channel along the floor pan 16 under an overlying aesthetic covering layer of plastic or other material that easily ruptures when the bladder is deployed in the event of an accident.

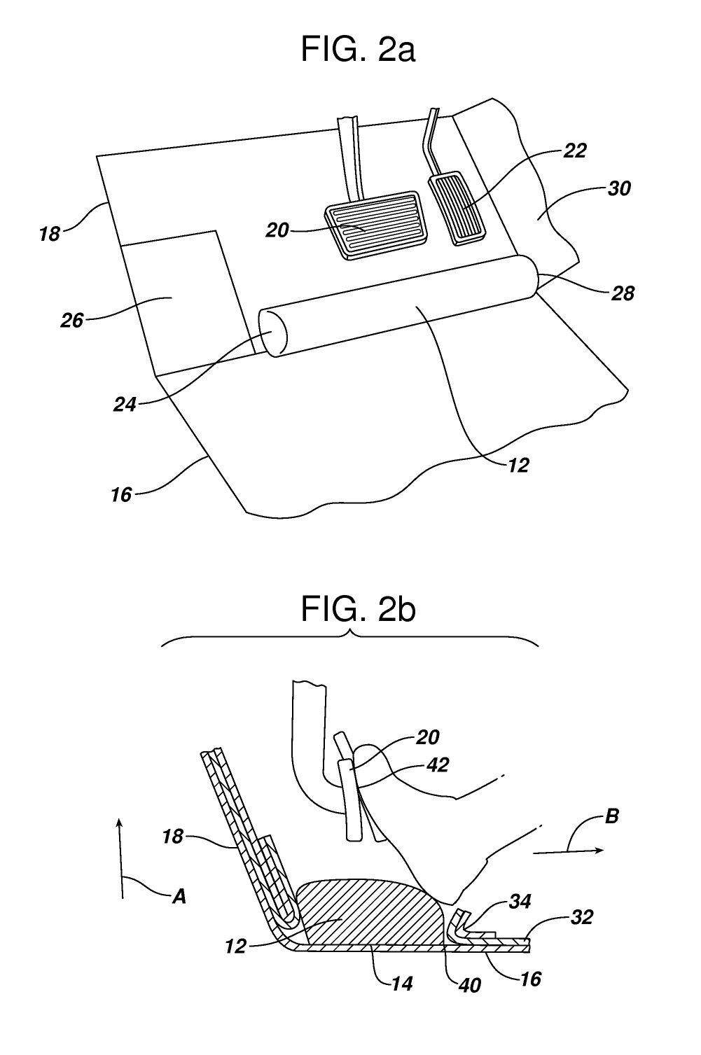

Reference is now made to FIGS. 2a and 2b illustrating the heel blocker 10 and more particularly, the inflatable bladder 12 in the fully deployed position. When deployed, the inflatable bladder 12 substantially fills the area bounded by a bottom 36 of the vehicle control pedals 20, 22, the toe pan 18 and the floor pan 16. Further it should be appreciated that the deployed bladder 12 extends continuously from the footrest 26 to the console or center tunnel 30 across the foot pedal operating area of the vehicle.

It should be appreciated as the bladder 12 is deployed, it inflates in a direction upwardly from the floor pan (note action arrow A) adjacent and along an interior face of the toe pan 18 toward the vehicle control pedals 20, 22. Here it should be appreciated that the rearmost and lowermost portion or corner 40 of the bladder 12 is secured to the floor pan 16. As a result it is not possible for the heel or toes of the vehicle operator to undercut or submarine the bladder 12 and extend forward between the bladder 12 and the floor pan 16 toward the toe pan 18. As a consequence, the best possible kinematics are maintained and s vehicle operator's legs are forced into a position where the knee bolster can provide protection thereby reducing or eliminating lower leg trauma. Further it should be appreciated that the inflation direction is substantially tangent to a control surface 42 of the vehicle pedals 20, 22 and thus to the soles of the operator's feet on the pedals. As a result, deployment or inflation of the bladder 12 does not provide a direct impact to the bottom of the feet.

In contrast, inflatable heel blockers of the prior art are mounted to the toe pan and inflate in a direction B toward the vehicle operator making a direct impact upon the heels or soles of the feet with a force additive to that of a frontal impact resulting from a head on collision or accident. Further, it should be appreciated that prior art inflatable bladders secured to the toe pan are, by definition not secured to the floor pan. Accordingly, the rearmost and lowermost corner of the inflated bladder remains free of the floor pan and potentially subject to undercutting or submarining by the toes or heels of the vehicle operator. Such an occurrence reduces the effectiveness of the bladder in maintaining proper kinematics for best driver safety during any accident event.

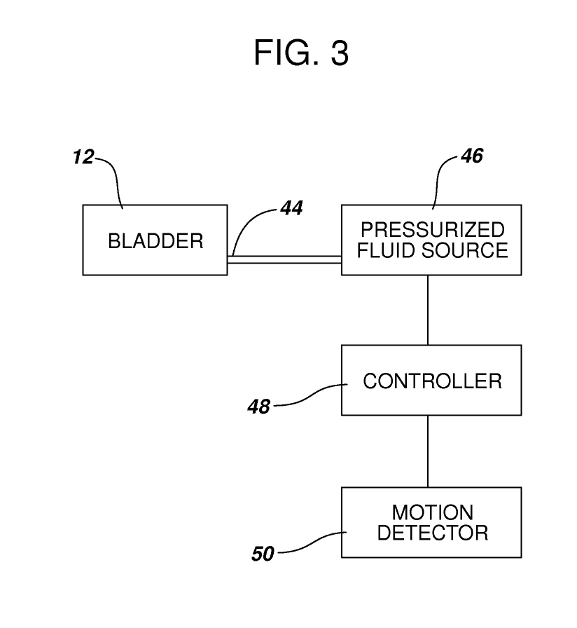

Reference is now made to FIG. 3. As illustrated, the inflatable bladder 12 includes an air inlet 44 in the form of a one-way valve connected to a pressurized fluid source 46. Pressurized fluid source 46 is connected to a controller 48 in the form of a microprocessor, which is responsive to one or more motion detectors 50, such as accelerometers or mercury switches, designed to detect sudden deceleration of a type characteristic of or associated with a head-on or off-set frontal collision necessitating the deployment of the heel blocker 10. When the detector 50 detects the sudden deceleration characteristic of a head-on collision event, an appropriate signal is sent to the controller 48 which immediately sends a signal to the pressurized fluid source 46 causing fluid under pressure to enter the bladder 12 through the air inlet 44. This causes the bladder 12 to deploy as illustrated in FIGS. 2A and 2B. In the illustrated embodiment, the noise insulation layer 32 and carpet layer 34 include respective scoring 52, 54 which weakens those layers so as to allow the inflatable bladder 12 to deploy through those layers past the scoring and upwardly along the face of the toe pan 18. In another possible embodiment, the bladder 12 simply inflates with such force that it pushes the overlying insulation material layer 32 and/or carpet layer 34 upwardly while still reaching the fully deployed position.

In order to ensure the most efficient and effective operation of the heel blocker 10, it is important that the bladder 12 is mounted with the utmost integrity to the floor pan 16. In one possible embodiment, the first portion 14 of the bladder 12 his heat welded to the floor pan 16. This may be done by hotplate welding which involves heating two plastics simultaneously and then bringing them together under pressure to create a plastic weld. Thus, in this instance the floor pan 16 would include plastic ribs (not shown) that are molded along with the first or lowermost portion 14 of the bladder 12 and then brought together under pressure and allowed to cool thereby creating a weld. In another possible embodiment the first portion 14 of the bladder 12 is heat staked to the floor pan 16 in accordance with known principles for heat staking. In other embodiments the first portion 14 of the bladder 12 is attached to the floor pan using clips, hooks, fasteners or other appropriate means.

A method of protecting the feet, heels and lower legs of an operator of a motor vehicle including a floor pan 16, toe pan 18 and operator pedals 20, 22 is described. That method may be broadly set forth as including the steps of securing an inflatable bladder 12 to the floor pan 16 adjacent the toe pan 18 and deploying that inflatable bladder into an area defined by a bottom of the vehicle control pedals 20, 22, the toe pan and the floor pan in the event of an accident. As should be appreciated, the bladder 12 inflates upwardly from the floor pan 16 adjacent and along an interior face of the toe pan 18 toward the vehicle control pedals 20, 22. This includes inflating the bladder 12 in a direction substantially at a tangent to a control surface of the vehicle control pedals 20, 22 (and to the heels and soles of the feet of the vehicle operator if the operator's toes are on the pedals). In accordance with the method, the mounting of the bladder 12 to the floor pan 16 is completed so that when deployed, the rearmost and lowermost portion of the bladder is secured to the floor pan. In this way it is possible to prevent any submarining of the deployed bladder by any portion of the vehicle operator's feet.

In summary, numerous benefits resolve from applying the concepts disclosed herein. More specifically, a heel blocker 10 is provided which in the home position sits flat along the floor pan 16 under the operating pedals 20, 22 adjacent the toe pan 18. Accordingly, the overlying carpet layer 34 lays flat in an aesthetically pleasing manner.

When the heel blocker 10 is deployed, it inflates in a direction upwardly from the floor pan 16 and substantially at a tangent to the control surfaces of the brake pedal 20 and accelerator pedal 22 and thus, the soles of the feet of the vehicle operator when on the pedals so as to not add to any impact force of a frontal collision. Further, the rearmost and lowermost portion of the deployed bladder 12 is firmly secured to the floor pan 16 to prevent any possible submarining of the device which could render it less effective in protecting the lower extremities of the operator.

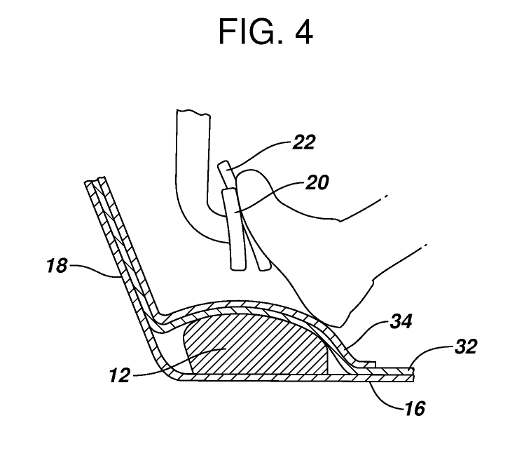

The foregoing has been presented for purposes of illustration and description. It is not intended to be exhaustive or to limit the embodiments to the precise form disclosed. Obvious modifications and variations are possible in light of the above teachings. For example, as illustrated in the FIG. 4 embodiment, the carpet layer 34 and insulation layer 32 are not scored. Instead of separating along a score line, they both balloon when the bladder 12 is deployed. All such modifications and variations are within the scope of the appended claims when interpreted in accordance with the breadth to which they are fairly, legally and equitably entitled.

1. An inflatable heel blocker for protecting an operator of a motor vehicle during an accident wherein said motor vehicle includes a floor pan, a toe pan forward of said floor pan and vehicle control pedals, said heel blocker comprising:
an inflatable bladder having a first portion secured to said floor pan adjacent said toe pan and underneath said vehicle control pedals.

2. The heel blocker of claim 1, wherein said inflatable bladder is exclusively mounted to said floor pan.

3. The heel blocker of claim 1, having a home position extending flat along said floor pan adjacent said toe pan and a deployed position in an area bounded by a bottom of said vehicle control pedals, said toe pan and said floor pan.

4. The heel blocker of claim 3, wherein said area of said deployed position is defined at a first end by a foot rest and at a second end by a console or center tunnel of said motor vehicle.

5. The heel blocker of claim 4, wherein said inflatable bladder inflates in a direction upwardly from said floor pan adjacent and along an interior face of said toe pan toward said vehicle control pedals and said rearmost and lowermost portion of said bladder is secured to said floor pan.

6. The heel blocker of claim 5, wherein said inflation direction is substantially at a tangent to a control surface of one of said vehicle control pedals.

7. The heel blocker of claim 1, wherein said first portion of said inflatable bladder is heat welded to said floor pan.

8. The heel blocker of claim 1, wherein said first portion of said inflatable bladder is heat staked to said floor pan.

9. The heel blocker of claim 18, wherein said inflatable bladder is secured to said floor pan underlying a carpet.

10. The heel blocker of claim 9, wherein said carpet overlying said inflatable bladder is scored to allow said inflatable bladder to deploy through said carpet along said scoring.

11. The heel blocker of claim 1, wherein said inflatable bladder is secured to said floor pan underlying a layer of noise insulation material and a layer of carpet.

12. The heel blocker of claim 11, wherein said layer of noise insulating material and said layer of carpet overlying said inflatable bladder are both scored to allow said inflatable bladder to deploy through said insulating material and carpet layers along said scoring.

13. The heel blocker of claim 1, wherein said inflatable bladder includes an air inlet and a pressurized fluid source is connected to said air inlet.

14. The heel blocker of claim 13, further including a controller and a motion sensor for detecting sudden deceleration associated with a motor vehicle accident, said controller being responsive to said motion sensor to activate said pressurized fluid source and deploy said inflatable bladder when said motion sensor detects said sudden deceleration associated with an accident.

15. The heel blocker of claim 1, wherein said inflatable bladder is made from a blow molded plastic material.

16. A method of protecting feet, heels and lower legs of an operator of a motor vehicle including a floor pan, a toe pan forward of said floor pan and vehicle control pedals, said method comprising:
securing an inflatable bladder to said floor pan adjacent said toe pan;
deploying said inflatable bladder into an area defined by a bottom of said vehicle control pedals, said toe pan and said floor pan in event of an accident.

17. The method of claim 16, including inflating said bladder upwardly from said floor pan adjacent and along an interior face of said toe pan toward said vehicle control pedals.

18. The method of claim 17, including inflating said bladder in a direction substantially at a tangent to a control surface of one of said vehicle control pedals.

19. The method of claim 18, including mounting said bladder to said floor pan so that when deployed a rearmost and lowermost portion of said bladder is secured to said floor pan.

20. A motor vehicle incorporating said inflatable heel blocker as set forth in claim 1.
